(19) United States
(12) Patent Application Publication
(10) Pub. No.: US 2026/0033651 A1
(43) Pub. Date: Feb. 5, 2026

(54) Flavor and Aroma Enhancing Aeration Drinking Vessel

(71) Applicants: Vance Lee, Mississauga (CA); Johnny Loh, Mississauga (CA)

(72) Inventors: Vance Lee, Mississauga (CA); Johnny Loh, Mississauga (CA)

(21) Appl. No.: 18/792,407

(22) Filed: Aug. 1, 2024

(51) Int. Cl. A47G 19/22; B01F 23/234

(52) U.S. Cl. CPC A47G 19/2205; B01F 23/234; A47G 2400/04

(57) ABSTRACT

A drinkware vessel for aerating and mixing beverages comprises an interior surface defining a cavity and a plurality of divergent ridges protruding from the interior surface. The divergent ridges include two pairs of bi-directional wave ramps disposed on opposing sides of the cavity. Swirling the beverage causes the divergent ridges to direct flow, induce mixing, and generate micro-bubbles by increasing liquid surface area. The vessel further comprises an upper portion with a rim and a headspace defining a diffusion chamber for capturing aroma molecules. The rim is shaped to direct beverage flow to a targeted palate area. The divergent ridges may have curved edges, taper in width, and facilitate a specific flow pattern. The vessel enhances aeration and mixing compared to vessels without divergent ridges.

### BACKGROUND

The present invention relates to drinkware for enhancing the aroma and flavor of beverages. More specifically, the invention pertains to cups and carafes with internal structures designed to aerate and mix beverages as the user swirls the drinkware.

Aeration is a well-known technique in the wine and whiskey industries for enhancing the flavor profile and releasing the aroma of beverages. By introducing oxygen to the beverage, the flavor develops and aromatic compounds are released, allowing the user to alter and enhance their sensory experience of the beverage.

Various devices have been developed to aerate beverages, particularly for wine. For example, U.S. Pat. No. 9,283,526 discloses a bottle with an internal aerator that aerates the beverage as it flows through the bottle before being dispensed. The aerator is a separate component retained entirely within the bottle neck and includes inlet and outlet ends, an outer wall contacting the bottle neck's interior surface, and a baffle between the ends.

Another example is U.S. Pat. No. 8,101,222, which describes a drinking container, such as a wine glass, for decanting, filtering, mixing and/or aerating a beverage. The container has a bowl with an upper opening and an aerating cell attached inside the bowl. The cell has a wall with perforations and an upwardly facing concave shape. As the beverage is poured into the cell, it flows through the perforations into the bowl, aerating the liquid in the process.

However, the prior art devices for aerating beverages focus primarily on wine bottles and decanters. While some patents, like the aforementioned U.S. Pat. Nos. 9,283,526 and 8,101,222, disclose individual glasses with aeration features, they do not describe the use of specifically designed internal ridges to aerate and mix beverages through the user's swirling motion.

Therefore, there remains a need for drinkware that can effectively aerate and mix beverages, using specially designed internal structures that enhance the user's control over the aeration process and the resulting flavor profile. The present invention aims to address this need by providing cups and carafes with unique internal ridge designs that optimize aeration and mixing through a simple swirling action.

### SUMMARY

In some aspects, the techniques described herein relate to a drinkware vessel for aerating and mixing beverages. The vessel comprises an interior surface defining a cavity for holding a liquid beverage, and a plurality of divergent ridges protruding from the interior surface and extending at least partially along a height of the cavity. The divergent ridges comprise two pairs of bi-directional wave ramps disposed on opposing sides of the cavity. Swirling the liquid beverage in the cavity causes the divergent ridges to direct the flow of the beverage and induce mixing and aeration by increasing a liquid surface area and generating a plurality of micro-bubbles in the beverage. The vessel further comprises an upper portion with a rim and a headspace above the liquid beverage when held in the cavity. The headspace defines a diffusion chamber that captures aroma molecules released from the beverage upon aeration, and the rim is shaped to direct the flow of the beverage to a targeted area of a drinker's palate.

In some embodiments, the divergent ridges comprise curved edges configured to facilitate a specific flow pattern of the liquid beverage when swirled. The divergent ridges may taper in width from a top portion to a bottom portion of the cavity. In one example, a width of the divergent ridges at the top portion is approximately 7.35 mm and tapers to approximately 2.92 mm at the bottom portion after completing a 180 degree rotation along the interior surface.

Swirling the liquid beverage in the cavity causes the divergent ridges to generate micro-bubbles in the beverage, thereby enhancing aeration compared to swirling in a vessel without the divergent ridges. The divergent ridges also coat the interior surface with a thin layer of the beverage, thereby increasing the liquid surface area and aroma release. Furthermore, the divergent ridges are configured to mix layers of the liquid beverage when swirled, obviating the need for a separate stirring utensil.

The drinkware vessel may comprise one of a glass, metal, a ceramic cup, or a carafe. The liquid beverage held in the vessel may be selected from coffee, tea, wine, vodka, gin, or whiskey. The techniques described herein also relate to a method of aerating and altering the flavor profile of a beverage using the drinkware vessel with divergent ridges.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is an aerial view of the interior of a preferred embodiment of the drinkware vessel, illustrating the divergent ridges protruding from the interior surface.

FIG. 2 is a cross sectional view of the exterior of a preferred embodiment of the drinkware vessel, depicting various dimensions.

FIG. 3 is a lateral view of the exterior of a preferred embodiment of the drinkware vessel, illustrating the outer protrusion of the divergent ridges.

FIG. 4 is a flow diagram illustrating a method of aerating and altering the flavor profile of a beverage using the drinkware vessel of the present invention.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

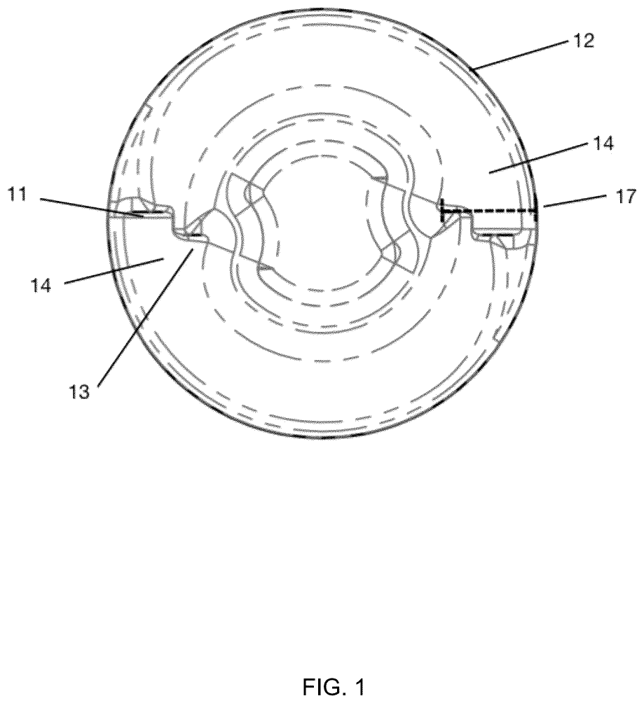

FIG. 1 is an arial view of the interior of a preferred embodiment of the drinkware vessel, illustrating the divergent ridges protruding from the interior surface 12. The divergent ridges comprise two pairs of bi-directional wave ramps 14 disposed on opposing sides of the cavity 10. At the top edge of the lower portion of the drinkware vessel, the divergent ridges 14 protrude inwards approximately 7.35 mm 11. The ridges 14 taper down to a protrusion of approximately 2.92 mm at 180 degrees 13, where the mirrored swirl begins on the opposite side of the drinkware vessel. The inner edge of the 2.92 mm protrusion 13 at the bottom of the drinkware vessel is located approximately 10.27 mm from the top-inner edge of the lower portion 17.

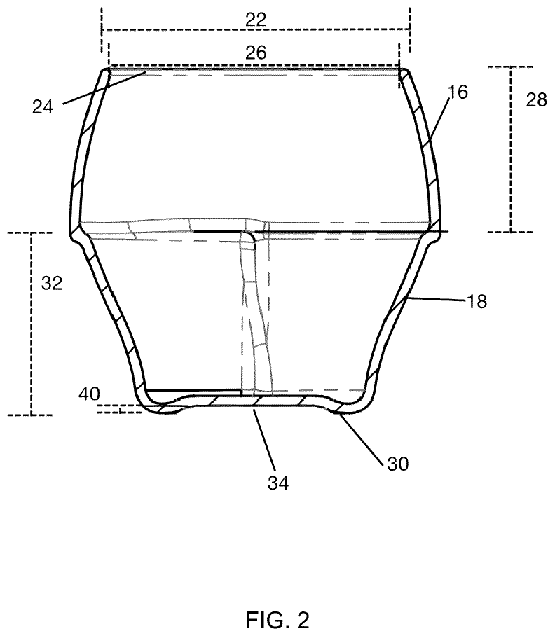

FIG. 2 is a lateral view of the exterior of a preferred embodiment of the drinkware vessel, depicting various dimensions. The widest diameter of the drinkware vessel, located where the upper portion 16 meets the lower portion 18, is approximately 75.13 mm. The outer diameter 22 of the rim 24 is approximately 62.46 mm, while the inner diameter 26 of the rim 24 is approximately 58.74 mm. The vertical distance 28 between the rim 24 and the bottom surface 30 of the lower portion 18 is approximately 32 mm. The vertical distance 32 between the top of the upper portion 16 and the bottom surface 30 is approximately 37 mm. The drinkware vessel features an indented bottom surface 34, with an outer diameter 36 of approximately 48.24 mm and an inner diameter 38 of approximately 23.68 mm. The depth 40 of the indented bottom surface 34 is approximately 1.5 mm.

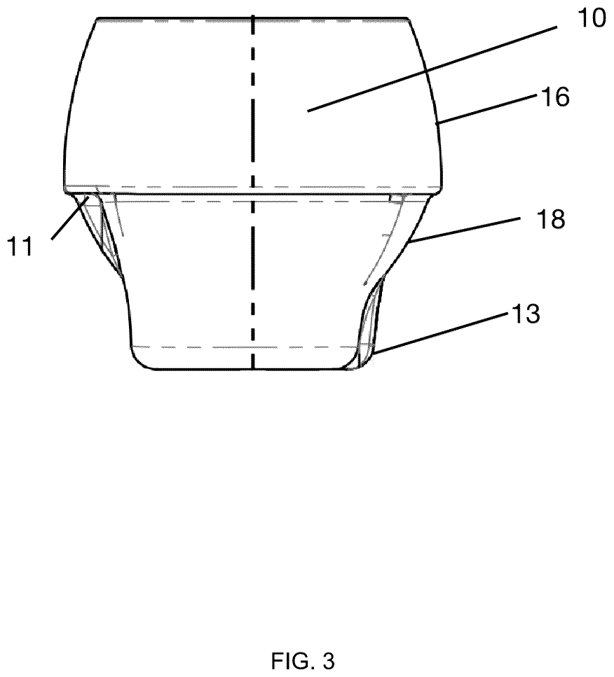

FIG. 3 is a lateral view of the exterior of a preferred embodiment of the drinkware vessel, illustrating the outer protrusion of the divergent ridges 14. At the top edge of the lower portion 18, the outer protrusion 11 of the divergent ridges 14 is approximately 7.35 mm. On the opposite side of the drinkware vessel, at the bottom, the outer protrusion 13 of the divergent ridges 14 is approximately 2.35 mm.

The interior surface 12 of the drinkware vessel defines a cavity 10 for holding a liquid beverage. When the liquid beverage is swirled within the cavity 10, the divergent ridges 14 direct the flow of the beverage and induce mixing and aeration by increasing the liquid surface area and generating a plurality of micro-bubbles in the beverage. The curved edges of the divergent ridges 14 facilitate a specific flow pattern of the liquid beverage when swirled.

The divergent ridges 14 taper in width from the top portion to the bottom portion of the cavity 10. This tapering allows for controlled cooling of the liquid beverage when swirled, enabling the drinker to experience a spectrum of flavors that evolve as the beverage cools. The mixing action induced by the divergent ridges 14 also obviates the need for a separate stirring utensil, as the ridges effectively mix layers of the liquid beverage when swirled.

The upper portion 16 of the drinkware vessel comprises a rim 24 and a headspace above the liquid beverage when held in the cavity 10. This headspace defines a diffusion chamber that captures aroma molecules released from the beverage upon aeration. The shape of the rim 24 is designed to direct the flow of the beverage to a targeted area of the drinker's palate, enhancing the overall drinking experience.

The drinkware vessel may be made from various materials, such as glass, metal, ceramic, or other suitable materials for holding liquid beverages. The vessel is particularly well-suited for aerating and mixing beverages such as coffee, tea, wine, whiskey, vodka, or gin, among others.

In an alternative embodiment, the divergent ridges 14 may have a width at the top portion of the cavity 10 ranging from approximately 4 mm to approximately 9 mm. The width of the divergent ridges 14 tapers down to a range of approximately 1 mm to approximately 4 mm at the bottom portion of the cavity 10. This range of tapering allows for optimal control over the mixing and aeration of the liquid beverage when swirled within the drinkware vessel.

The cavity 10 of the drinkware vessel may have a widest diameter ranging from approximately 60 mm to approximately 90 mm. This range of diameters provides a suitable volume for holding and swirling a liquid beverage while maintaining a comfortable size for handling by the user.

The rim 24 of the drinkware vessel may have an outer diameter ranging from approximately 50 mm to approximately 80 mm and an inner diameter ranging from approximately 45 mm to approximately 75 mm. These ranges allow for a comfortable and secure lip contact surface for the user while maintaining a sufficient opening for consuming the liquid beverage.

In some embodiments, the drinkware vessel may include an indented bottom surface 34 on the bottom portion opposite the upper portion 16. The indented bottom surface 34 may have an outer diameter ranging from approximately 42 mm to approximately 60 mm and an inner diameter ranging from approximately 20 mm to approximately 30 mm. The depth of the indented bottom surface 34 may range from approximately 1 mm to approximately 3 mm. This indented bottom surface 34 provides additional stability to the drinkware vessel when placed on a flat surface.

The vertical distance between the rim 24 and a bottom surface 30 of the drinkware vessel may range from approximately 28 mm to approximately 50 mm. Similarly, the vertical distance between the top of the upper portion 16 and the bottom surface 30 of the drinkware vessel may also range from approximately 28 mm to approximately 50 mm. These ranges provide a comfortable and ergonomic height for the user to grasp and handle the drinkware vessel.

The ranges described in this alternative embodiment allow for variations in the dimensions of the drinkware vessel while still maintaining the key functional features of the divergent ridges 14 for mixing and aerating the liquid beverage. The specific dimensions within these ranges may be selected based on factors such as the intended beverage type, serving size, and user preferences. By providing these ranges, the drinkware vessel offers flexibility in design and manufacturing while preserving the essential characteristics of the invention.

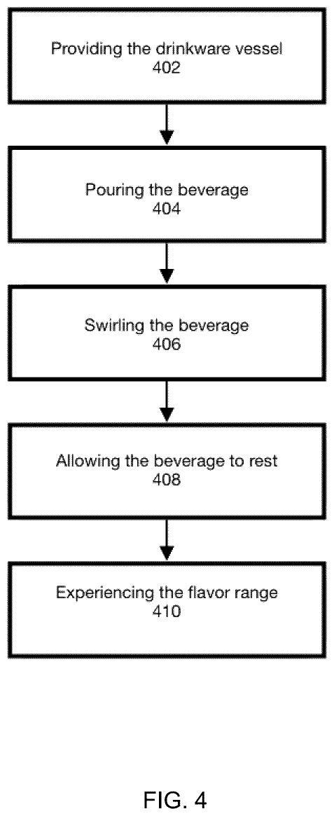

FIG. 4 is a flow diagram illustrating a method of aerating and altering the flavor profile of a beverage using the drinkware vessel of the present invention. The method begins at step 402 by providing the drinkware vessel comprising an interior surface 12 defining a cavity 10 for holding a liquid beverage. The interior surface 12 includes a plurality of divergent ridges 14 comprising two pairs of bi-directional wave ramps disposed on opposing sides of the cavity 10 and extending at least partially along a height of the cavity 10.

In one embodiment, the plurality of divergent ridges 14 have curved edges configured to facilitate a specific flow pattern of the beverage when swirled. The divergent ridges 14 may taper in width from a top portion 16 to a bottom portion 18 of the cavity 10. For example, the width of the divergent ridges 14 at the top portion 16 may be approximately 5-8 mm and taper to approximately 1-4 mm at the bottom portion 18 after completing a 180 degree rotation along the interior surface 12.

The method continues at step 404 by pouring the liquid beverage, such as coffee, tea, wine, vodka, gin, or whiskey, into the cavity 10 of the drinkware vessel. At step 406, the user then swirls the beverage in the vessel, causing the divergent ridges 14 to direct the flow of the beverage and induce aeration. This swirling action increases the liquid surface area by coating the interior surface 12 with a thin layer of the beverage and generates a plurality of micro-bubbles in the beverage.

Step 408 involves allowing the beverage to rest momentarily after swirling, which enables aroma molecules released during aeration to be captured in the headspace above the beverage. The unique shape profile of the vessel's rim, having an outer diameter 22 and an inner diameter 26, is configured to focus these captured aroma molecules towards the drinker's nose and mouth when consuming the beverage.

The aeration caused by swirling not only alters the flavor profile of the beverage but also allows the user to experience a range of flavors expressed by the beverage at different temperatures, as indicated at step 410. Additionally, the mixing action of the divergent ridges 14 helps to blend layers of the beverage, providing a more balanced flavor from the first sip to the last.

In various embodiments, the vertical distance 28 between the rim and the bottom surface of the lower portion 18 may be approximately 28-50 mm. Similarly, the vertical distance 32 between the top of the upper portion 16 and the bottom surface may also be approximately 28-50 mm.

The drinkware vessel may further include an indented bottom surface 34 at the bottom portion 18, opposite the upper portion 16. This indented bottom surface 34 may have an outer diameter 36 of approximately 42-60 mm, an inner diameter 38 of approximately 20-30 mm, and a depth 40 of approximately 1-3 mm.

The divergent ridges 14 may have an outer protrusion 42 at the top edge of the lower portion 18 and an outer protrusion 44 at the bottom of the cavity 10. These protrusions contribute to the flow pattern and aeration of the beverage when swirled.

In summary, the method of using the uniquely designed drinkware vessel enhances the aroma, flavor, and overall sensory experience of consuming various beverages. The divergent ridges 14 and the vessel's shape work together to aerate the beverage, mix flavors, and focus key aromatic compounds for the drinker's enjoyment.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A drinkware vessel for aerating and mixing beverages, comprising:
an interior surface defining a cavity for holding a liquid beverage;
a plurality of divergent ridges protruding from the interior surface and extending at least partially along a height of the cavity, wherein the divergent ridges comprise two pairs of bi-directional wave ramps disposed on opposing sides of the cavity;
wherein swirling the liquid beverage in the cavity causes the divergent ridges to direct the flow of the beverage and induce mixing and aeration by increasing a liquid surface area and generating a plurality of micro-bubbles in the beverage; and
an upper portion comprising a rim and a headspace above the liquid beverage, the headspace defining a diffusion chamber that captures aroma molecules released from the beverage upon said aeration, the rim shaped to direct the flow of the beverage to a targeted area of a drinker's palate.

2. The drinkware vessel of claim 1, wherein the divergent ridges comprise curved edges configured to facilitate a specific flow pattern of the liquid beverage when swirled.

3. The drinkware vessel of claim 1, wherein the divergent ridges taper in width from a top portion to a bottom portion of the cavity.

4. The drinkware vessel of claim 3, wherein the width of the divergent ridges at the top portion is approximately 4-9 mm and tapers to approximately 1-4 mm at the bottom portion after completing a 180 degree rotation along the interior surface.

5. The drinkware vessel of claim 1, wherein swirling the liquid beverage in the cavity causes the divergent ridges to generate micro-bubbles in the beverage, thereby enhancing aeration compared to swirling in a vessel without the divergent ridges.

6. The drinkware vessel of claim 1, wherein swirling the liquid beverage in the cavity causes the divergent ridges to coat the interior surface with a thin layer of the beverage, thereby increasing the liquid surface area and aroma release.

7. The drinkware vessel of claim 1, wherein the divergent ridges are configured to mix layers of the liquid beverage when swirled, obviating the need for a separate stirring utensil.

8. The drinkware vessel of claim 1, wherein the divergent ridges enable controlled cooling of the liquid beverage when swirled, allowing a drinker to experience a spectrum of flavors that evolve as the beverage cools.

9. The drinkware vessel of claim 1, wherein the drinkware vessel comprises one of a glass, metal, a ceramic cup, or a carafe.

10. The drinkware vessel of claim 1, wherein the liquid beverage comprises one of coffee, tea, wine, vodka, gin or whiskey.

11. A method of aerating and altering the flavor profile of a beverage, the method comprising:
providing a drinkware vessel comprising an interior surface defining a cavity for holding a liquid beverage, the interior surface comprising a plurality of divergent ridges comprising two pairs of bi-directional wave ramps disposed on opposing sides of the cavity and extending at least partially along a height of the cavity;
pouring the liquid beverage into the cavity of the vessel;
swirling the beverage in the vessel, thereby causing the divergent ridges to direct the flow of the beverage and induce aeration by increasing a liquid surface area and generating a plurality of micro-bubbles in the beverage;
allowing aroma molecules released upon said aeration to be captured in a headspace above the beverage; and
consuming the aerated beverage from the vessel, whereby the aeration alters the flavor profile of the beverage and the captured aroma molecules are focused to a drinker's nose and mouth by a rim of the vessel.

12. The method of claim 17, wherein the plurality of divergent ridges comprise curved edges configured to facilitate a specific flow pattern of the beverage.

13. The method of claim 17, wherein the plurality of divergent ridges are configured to create micro-bubbles in the beverage upon swirling.

14. The method of claim 17, wherein swirling the beverage in the vessel increases a surface area of the beverage by coating an interior wall of the vessel with a thin layer of the beverage.

15. The method of claim 17, wherein the aeration caused by swirling the beverage allows a user to alter a temperature of the beverage and experience a range of flavors that the beverage expresses at different temperatures.

16. The method of claim 17, wherein the plurality of divergent ridges are configured to mix layers of the beverage upon swirling, thereby providing a more balanced flavor from a first sip to a last sip.

17. The method of claim 17, wherein the beverage is selected from the group consisting of coffee, tea, wine, vodka, gin, and whiskey.

18. The method of claim 17, wherein the drinkware vessel is a wine glass, a whiskey glass, a carafe, a metal vessel, a mug, or a cup.

19. The method of claim 17, wherein the drinkware vessel further comprises a rim having a unique shape profile configured to direct flow of the beverage to different areas of a drinker's palate.

20. The method of claim 17, wherein the plurality of divergent ridges taper in width from atop portion to a bottom portion of the cavity.
